(19) United States
(12) Patent Application Publication
(10) Pub. No.: US 2008/0120578 A1
(43) Pub. Date: May 22, 2008

(54) MOUSE WITH A SCREEN SAVER CONTROL FUNCTION

(75) Inventors: Han-Che Wang, Shenzhen (CN); Hua-Dong Cheng, Shenzhen (CN); Xiao-Guang Li, Shenzhen (CN); Kuan-Hong Hsieh, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/685,200

(22) Filed: Mar. 12, 2007

(30) Foreign Application Priority Data
Nov. 17, 2006 (CN) 200610156906.8

(51) Int. Cl. G06F 3/048

(52) U.S. Cl. 715/867

(57) ABSTRACT

A mouse with a screen saver control function is provided. The mouse includes a left button, a right button, a scroll button, a screen saver control button, a memory unit, and a micro-processing unit. The memory unit stores a simulation program. When receiving a signal from the screen saver control button, the micro-processing unit runs the simulation program of the memory unit, and generates simulated input signals to a computer connected thereto, and thus to prevent the computer from running a screen saver program. Utilizing the mouse, a computer user can control a screen saver of the computer momentarily, without resetting a duration of initiating the screen saver program. Therefore, the mouse is very convenient for the computer user to control the computer.

### BACKGROUND of the Invention

1. Field of the Invention

The present invention relates to a mouse, and particularly to a mouse with a screen saver control function.

2. Description of Related Art

In today's computer operating systems, one can set an idle time to enable a screen saver on a display screen of a computer or to enable a computer lock function. No matter what a length of the idle time is, long or short, once the idle time has been set, the screen saver or the computer lock is enabled when the idle time is reached. If a computer user doesn't operate the computer during the idle time, the computer enables a screen saver, and the computer user must input a computer password to disable the screen saver or unlock the computer. Furthermore, when the computer user is away from the computer, the computer screen does not immediately enables the screen saver/lock function, rather, the computer waits until the idle time is reached before enabling the screen saver/lock function. Consequently, the display screen may still be operating for a long time, leading to shortened work life of the display screen. Furthermore, during this time, other computer user may operate the computer when the computer user is away, a data security hazard of data of the computer user.

### SUMMARY OF THE INVENTION

A mouse with a screen saver control function is provided. The mouse includes a screen saver control button configured for generating a signal when receiving an operational input from a computer user; a memory unit for storing a simulation program; and a micro-processing unit configured for running the simulation program when receiving the signal from the screen saver control button, and generating simulated input signals to a computer connected thereto.

Other advantages and novel features will be drawn from the following detailed description with reference to the attached drawing, in which:

### BRIEF DESCRIPTION OF THE DRAWINGS

FIG. 1 is a perspective diagram of a mouse with a screen saver control function in accordance with a preferred embodiment of the present invention; and

FIG. 2 is a block diagram of a hardware infrastructure of the mouse of FIG. 1 in accordance with a preferred embodiment of the present invention.

### DETAILED DESCRIPTION OF THE INVENTION

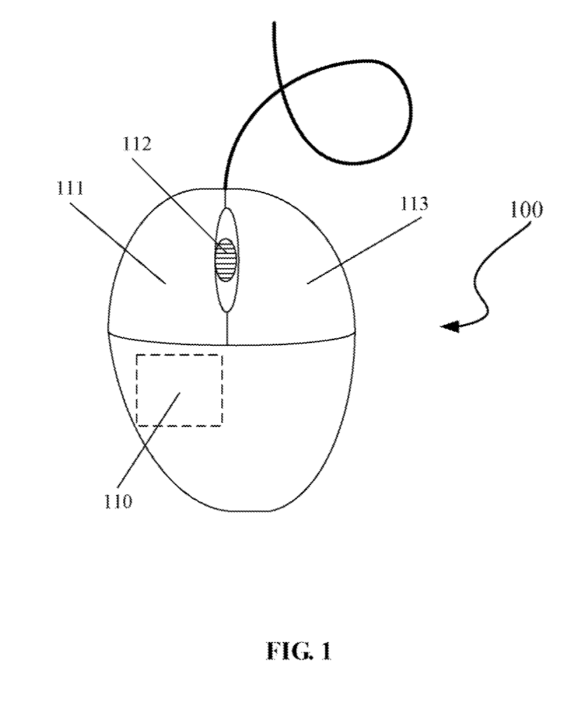

FIG. 1 is a perspective diagram of a mouse with a screen saver control function in accordance with a preferred embodiment of the present invention. The mouse 100 includes a left button 111, a right button 113, a scroll button 112, and a screen saver control button 110. The screen saver control button 110 is configured at an appropriate position that is reachable by a thumb when the mouse is operated. For example, in the preferred embodiment as that shown in FIG. 1, the screen saver control button 110 is configured at the position indicated by dotted lines.

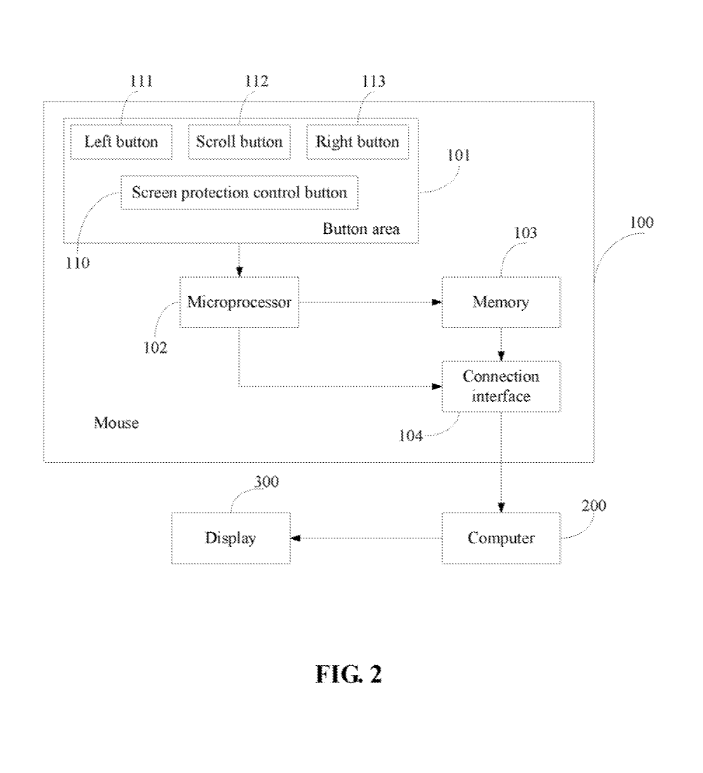

FIG. 2 is a block diagram of a hardware infrastructure of the mouse 100 of FIG. 1 in accordance with a preferred embodiment of the present invention. The mouse 100 includes a button area 101, a microprocessor 102, a memory 103, and a connection interface 104. The connection interface 104 is configured for connecting the mouse 100 to a computer 200. The button area 101 includes the left button 111, the right button 113, the scroll button 112, and the screen saver control button 110. The microprocessor 102 is configured for performing corresponding instructions according to input signals received from the button area 101. The screen saver control button 110 is configured for generating a screen saver signal when the screen saver control button 110 is operated. The memory 103 stores a simulation program. When the microprocessor 102 receives the screen saver signal from the screen saver control button 110, the microprocessor 102 invokes the simulation program and generates simulated input signals. The simulated input signals may be preconfigured to be same as the input signals generated by generic input buttons, such as the left button 111, the right button 113, the scroll button 112, or a keyboard (not shown).

If the microprocessor 102 receives the screen saver signal from the screen saver control button when the simulation program is not invoked, the microprocessor 102 invokes the simulation program to generate the simulated input signals. The microprocessor 102 transmits the simulated input signals to the connected computer through the connection interface 104, and thus to preventing the computer 200 from enabling a screen saver program.

When the simulation program is invoked, the microprocessor 102 does not respond to the input signals from the buttons other than the screen saver control button in the button area 101 such as the left button 111, the right button 113, and the scroll button 112. If the microprocessor 102 receives the screen saver signal from the screen saver control button when the simulation program is invoked, the microprocessor 102 terminates the simulation program so as to perform the corresponding instructions according to the input signals received from the button area 101.

If the microprocessor 102 receives successive (e.g., 2) screen saver signals from the screen saver control button 110 in a short predetermined time period (e.g., 0.5 s) when the simulation program is not invoked, the microprocessor 102 sends a screen saver instruction to the connected computer 200, to activate the screen saver program. Consequently, the screen saver program is enabled.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A mouse with a screen saver control function, comprising:
a screen saver control button configured for generating a signal when receiving an operational input from a computer user;
a memory unit for storing a simulation program; and
a micro-processing unit configured for running the simulation program when receiving the signal from the screen saver control button, and generating simulated input signals to a computer connected thereto.

2. The mouse as recited in claim 1, wherein the micro-processing unit is for further sending a screen saver instruction to activate the computer to run a screen saver program, when receiving successive signals from the screen saver control button in a predetermined time period.

3. The mouse as recited in claim 2, wherein a number of the successive signals from the screen saver control button is two.

4. The mouse as recited in claim 1, wherein the micro-processing unit is for interrupting running the simulation program, when receiving a new signal from the screen saver control button.

5. The mouse as recited in claim 1, wherein the screen saver control button is configured at an appropriate position where a thumb can touch.
